(19) United States
(12) Patent Application Publication
(10) Pub. No.: US 2014/0176497 A1
(43) Pub. Date: Jun. 26, 2014

(54) METHOD OF AVOIDING MUTUAL INTERFERENCE OF TOUCH DETECTION WITH LCD SCAN

(71) Applicant: FocalTech Systems, Ltd., Grand Cayman (KY)

(72) Inventors: Michael Mo, Shenzhen (CN); Xinxi Jiang, Shenzhen (CN); Junqiao Liu, Shenzhen (CN)

(73) Assignee: FocalTech Systems, Ltd., Grand Cayman (KY)

(21) Appl. No.: 14/133,116

(22) Filed: Dec. 18, 2013

(30) Foreign Application Priority Data
Dec. 21, 2012 (CN) 201210561351.0

(51) Int. Cl. G06F 3/041

(52) U.S. Cl. CPC G06F 3/0418
USPC 345/174

(57) ABSTRACT

A method of avoiding the mutual interference of touch detection with LCD scan, based on the LCD touch screen set with capacitive touch sensor. As to the said method, first of all, divide the entire LCD touch screen into at least two regions; then, set the touch detection timing sequence and LCD scan timing sequence for the LCD touch screen, enabling the touch detection process and LCD scan process to meet the condition of only conducting one process of touch detection process and LCD scan process within the same time period and same region, thus, enabling both of the touch detection process and LCD scan process to keep mutual independent running status either in time domain or in spatial domain. The invention has separated the touch detection process and LCD scan process from time domain and spatial domain, avoiding mutual interaction and mutual interference of the two processes.

The present application claim priority of Chinese patent application Serial No. 201210561351.0, filed Dec. 21, 2012, the content of which is hereby incorporated by reference in its entirely.

### TECHNICAL FIELD

The invention relates to a process treatment method of effectively shielding the interference between two treatment processes by facilitating two treatment processes, especially relates to and applicable to a method for treatment of touch detection and LD scan process for LCD touch screen set with capacitive touch sensor.

### BACKGROUND ART

As to the existing technology, capacitive touch sensor and LCD are integrated to be LCD touch screen. Obviously, LCD touch screen comprises capacitive touch sensor components and LCD components. For LCD touch screen of the earlier period, capacitive touch sensor was installed on the basis of LCD, namely, capacitive touch sensor components were simply installed on the LCD components. With the requirement of developing towards thinner structures for LCD touch screen, both of the said capacitive sensor components and LCD components are improved to be thinner structures, thus, capacitive touch sensor components and LCD components are combined into one organically, i.e. both capacitive touch sensor components and LCD components are respectively divided into several layers, each layer of the components of the capacitive sensor components are inserted between LCD component layers, thus, mutual components for capacitive sensor components and LCD components are saved, so as to enable LCD touch screen to be thinner. Nevertheless, at the same time of developing towards thinner structures for LCD touch screen of the existing technology, because key components of capacitive sensor components and key components of LCD components are closer and closer at distance, namely, drive electrode layer and sensing electrode layer of the capacitive sensor components are more and more intimate with the thin film transistor layers of the LCD components, touch detection process completed by capacitive sensor components and LCD scan process completed by LCD components are sure to be mutually affected and mutually interfered, under serious circumstances, performance of capacitive sensor components and LCD components will decrease substantially. Therefore, a method is required to enable mutual noninterference of touch detection process of LCD touch screen and LCD scan process.

### CONTENT OF THE INVENTION

The invention is intended to solve the technical issues so as to provide a method of avoiding mutual interference of touch detection with LCD scan by means of avoiding the deficiencies of the existing technology. Completion of respective process with noninterference to each other is realized through isolation of touch detection and LCD scan in the time domain or spatial domain.

The following technical solution can be adopted for the purpose of addressing the said technical issues of the invention:

A method of avoiding mutual interference of touch detection with LCD scan, based on LCD touch screen set with capacitive touch sensor; the said LCD touch screen comprises LCD components and capacitive touch sensor components; the said capacitive touch sensor components and the LCD components are mutually independent and laminated, set to be LCD touch screen, or the said capacitive touch sensor components are inserted between LCD component layers to form LCD touch screen; in particular, the said method comprises the following steps:

A. Divide the whole LCD touch screen into at least two regions;

B. Set touch detection timing sequence and LCD scan sequence of the LCD touch screen, enabling the touch detection process and LCD scan process to meet a process of merely conducting touch detection process and LCD scan process within the same time interval and same region, namely, merely conducting touch detection process and LCD scan process within the same region and same time interval, thus, enabling touch detection process and LCD scan process to keep mutually independent running state either within time domain or spatial domain.

Specifically speaking, the said Step B comprises the following substeps:

B11. Set sequence of regions executing LCD scan process in the course of completing a frame of LCD scanning data, set sequence of regions executing touch detection process in the course of completing a frame of touch detection data, and ensure that regions executing LCD scan process do not coincidence with regions executing touch detection process within the same time period; the said coincidence includes overlap and intersection.

The invention can also be realized by means of setting respective regions for two kinds of processes, the said Step A comprises the following substeps.

A21. Separate the entire LCD touch screen into at least two touch detection regions seamlessly without overlapping each other;

A22. Then, separate each touch detection region into at least two LCD scan regions seamlessly without overlapping each other;

Then, Step B comprises the following sub-steps:

B21. Set the sequence of LCD scan regions executing LCD scan process in the course of completing a frame of LCD scanning data;

B22. Set the sequence of touch detection regions executing touch detection process in the course of completing a frame of touch detection data;

B23. Facilitate the sequences stated in sub-step B21 and B22, ensure that LCD scan regions executing LCD scan process do not coincide with touch detection regions executing touch detection process within the same time period; the said coincidence includes overlap and intersection.

To further ensure that sequence of regions executing two processes do not conflict, and timely update sequence of regions executing the processes, the said Step B23 further comprises the following substeps:

B24. Return to execute Substep B21 after the completion of each one cycle of touch detection process, namely after obtaining a frame of touch detection data;

B25. Return to execute Substep B22 after the completion of each one cycle of LCD scan process, namely obtaining a frame of LCD scanning data.

Similar to the above proposal, the said Step A comprises the following substeps:

A51. Separate the entire LCD touch screen into at least two LCD scan regions seamlessly without overlapping each other;

A52. Then, separate each LCD scan region into at least two touch detection regions seamlessly without overlapping each other;

Then, Step B comprises the following sub-steps:

B51. Set the sequence of LCD scan regions executing LCD scan process in the course of completing a frame of LCD scanning data;

B52. Set the sequence of touch detection regions executing touch detection process in the course of completing a frame of touch detection data;

B53. Facilitate the sequences stated in Substep B51 and B22, ensure that LCD scan regions executing LCD scan process do not coincide with touch detection regions executing touch detection process within the same time period; the said coincidence includes overlap and intersection. To timely update the sequence of regions executing processes, the said Step B53 further comprises the following substeps:

B54. Return to execute Substep B51 after the completion of each one cycle of LCD scan process, namely obtaining a frame of LCD scanning data;

B55. Return to execute Substep B52 after the completion of each one cycle of touch detection process, namely after obtaining a frame of touch detection data.

When regions executing two processes coincide, the completion of the two processes with noninterference to each other within the same region can be realized by means of time-sharing control of the two processes, the said Step B also comprises the following substeps:

B31. Assign a touch detection sub-cycle for each region, thus, when touch detection process in all regions are completed, a complete touch detection cycle is completed, and a frame of touch detection data are obtained;

B32. Assign an LCD sub-cycle for each region, thus when LCD scan process in all regions are completed, a complete LCD scan cycle is completed, and a frame of LCD scanning data are obtained;

B33. Set either of the said LCD scan process or touch detection process to be master process, while the other process to be slave process; then, the cycle corresponding to the master process shall be major cycle, the sub-cycle corresponding to the said master process shall be sub-cycle of the master process; the cycle corresponding to the said slave process is slave cycle, the sub-cycle corresponding to the said slave process is the sub-cycle of the slave process; execute the following Substep B34-B37 during each major cycle:

B34. Judge whether the execution region of the master process corresponding to the sub-cycle of the master process to be executed coincides with the execution region of the slave process corresponding to the sub-cycle of the slave process to be executed or being executed, if so, execute Substep B35-B36, if not, execute Substep B37; the said coincidence includes overlap and intersection;

B35. If sub-cycle of the slave process is being executed, discontinue the execution of the master process, after the sub-cycle of the slave process is completed, discontinue the slave process, start the master process and complete the said sub-cycle of the master process to be executed, discontinue the master process after the completion of the sub-cycle of the master process; return to Substep B34;

B36. If sub-cycle of the slave process is to be executed, discontinue the execution of the slave process, start the master process and complete the said sub-cycle of the master process to be executed, after the completion of the said sub-cycle of the master process, discontinue the master process, start the slave process; return to Substep B34;

B37. Execute the master process and the slave process simultaneously, after the master process has completed the said sub-cycle of the master process to be executed, return to Substep B34.

The aforementioned time-sharing process control method is also applicable to the proposal of setting regions respectively for two processes, the said Step A comprises the following substeps:

A41. Separate the entire LCD touch screen into at least two touch detection regions seamlessly without overlapping each other;

A42. Then, separate each touch detection region into at least two LCD scan regions seamlessly without overlapping each other;

Then, Step B comprises the following sub-steps:

B41. Assign a touch detection sub-cycle to each touch detection region, thus, when touch detection process in all touch detection regions are completed, an entire touch detection cycle is completed, and a frame of touch detection data are obtained;

B42. Assign an LCD sub-cycle to each LCD scan region, thus, when LCD scan process in all LCD scan regions are completed, an entire LCD scan cycle is completed, and a frame of LCD scanning data are obtained;

B43. Set either of the said LCD scan process or touch detection process to be master process, while the other process to be slave process; then, the cycle corresponding to the master process shall be major cycle, the sub-cycle corresponding to the said master process shall be sub-cycle of the master process; the cycle corresponding to the said slave process is slave cycle, the sub-cycle corresponding to the said slave process is the sub-cycle of the slave process; execute the following Substep B44-B47 during the completion of one master cycle;

B44. Judge whether the execution region of the master process corresponding to the sub-cycle of the master process to be executed coincides with the execution region of the slave process corresponding to the sub-cycle of the slave process to be executed or being executed, if so, execute Substep B45-B46, if not, execute Substep B47; the said coincidence includes overlap and intersection;

B45. If sub-cycle of the slave process is being executed, discontinue the execution of the master process, after the sub-cycle of the slave process is completed, discontinue the slave process, start the master process and complete the said sub-cycle of the master process to be executed, discontinue the master process after the completion of the sub-cycle of the master process; return to Substep B44;

B46. If sub-cycle of the slave process is to be executed, discontinue the execution of the slave process, start the master process and complete the said sub-cycle of the master process to be executed, after the completion of the said sub-cycle of the master process, discontinue the master process, start the slave process; return to Substep B44;

B47. Execute the master process and the slave process simultaneously, after the master process has completed the said sub-cycle of the master process to be executed, return to Substep B44.

Similar to the above proposal, the said Step A comprises the following substeps:

A61. Separate the entire LCD touch screen into at least two LCD scan regions seamlessly without overlapping each other;

A62. Then, separate each LCD scan region into at least two touch detection regions seamlessly without overlapping each other;

Then, Step B comprises the following sub-steps:

B61. Assign a touch detection sub-cycle to each touch detection region, thus, when touch detection process in all touch detection regions are completed, an entire touch detection cycle is completed, and a frame of touch detection data are obtained;

B62. Assign an LCD sub-cycle to each LCD scan region, thus, when LCD scan process in all LCD scan regions are completed, an entire LCD scan cycle is completed, and a frame of LCD scanning data are obtained;

B63. Set either of the said LCD scan process or touch detection process to be master process, while the other process to be slave process; then, the cycle corresponding to the master process shall be major cycle, the sub-cycle corresponding to the said master process shall be sub-cycle of the master process; the cycle corresponding to the said slave process is slave cycle, the sub-cycle corresponding to the said slave process is the sub-cycle of the slave process; execute the following Substep B64-B67 during the completion of one master cycle;

B64. Judge whether the execution region of the master process corresponding to the sub-cycle of the master process to be executed coincides with the execution region of the slave process corresponding to the sub-cycle of the slave process to be executed or being executed, if so, execute Substep B65-B66, if not, execute Substep B67; the said coincidence includes overlap and intersection;

B65. If sub-cycle of the slave process is being executed, discontinue the execution of the master process, after the sub-cycle of the slave process is completed, discontinue the slave process, start the master process and complete the said sub-cycle of the master process to be executed, discontinue the master process after the completion of the sub-cycle of the master process; return to Substep B64;

B66. If sub-cycle of the slave process is to be executed, discontinue the execution of the slave process, start the master process and complete the said sub-cycle of the master process to be executed, after the completion of the said sub-cycle of the master process, discontinue the master process, start the slave process; return to Substep B64;

B67. Execute the master process and the slave process simultaneously, after the master process has completed the said sub-cycle of the master process to be executed, return to Substep B64.

Compared with existing technologies, technical effects of the invention “a method of avoiding mutual interference of touch detection with LCD scan” lie in:

The invention enables touch detection process and LCD scan process of the LCD touch screen to be executed within the same time interval and different regions, or to be conducted within the same region and different time interval, isolate the touch detection process and LCD scan process in time domain and spatial domain, so as to avoid the mutual impact and mutual interference of the two processes, clearing the technical obstacles for LCD touch screen to develop towards thinner structures and breaking through the bottleneck hindering development.

### DESCRIPTION OF FIGURES

FIG. 1: schematic diagram of region division for the first embodiment of the “method of avoiding mutual interference of touch detection with LCD scan” of the invention;

FIG. 2: schematic diagram of region division for the second embodiment of the invention;

FIG. 3: schematic diagram of regional coincidence positional relation for overlapping regions;

FIG. 4: schematic diagram of regional coincidence positional relation for intersecting regions.

### MODE OF CARRYING OUT THE INVENTION MODEL

To further illustrate the principle and structure of the invention, the invention is further described in detail in accordance with the preferable embodiments shown in the figures.

The invention has put forward a method of avoiding the mutual interference of touch detection with LCD scan, based on the LCD touch screen set with capacitive touch sensor. Just as stated in the existing technology, the said LCD touch screen comprises LCD components and capacitive touch sensor components. The said capacitive touch sensor components and LCD components are mutually independent and laminated set to be LCD touch screen, or the said capacitive touch sensor components are inserted between layers in the LCD components to be LCD touch screen. The said method comprises the following steps:

A. Divide the whole LCD touch screen into at least two regions;

B. Set touch detection timing sequence and LCD scan sequence of the LCD touch screen, enabling the touch detection process and LCD scan process to meet a process of merely conducting touch detection process and LCD scan process within the same time interval and same region, namely, merely conducting touch detection process and LCD scan process within the same region and same time interval, thus, enabling touch detection process and LCD scan process to keep mutually independent running state either within time domain or spatial domain.

The invention intends to enable touch detection process and LCD scan process concurrently executed to be executed within different regions at different time period by means of region division, in this way, the two processes perform at the same time but different regions. The region executing one process is free from being affected by the other process, while to the process itself, it is the state of maintaining continuous execution, realizing the isolation of two processes via spatial domain within the same time domain. When two processes are inevitably executed in the same region, time-sharing execution shall be adopted, namely, allocating corresponding time frame for two processes respectively, completing only one process of the two within one time frame, and completing the other process within the other time frame, realizing coincidence of two processes within spatial domain, while isolation within time domain. Therefore, the invention has isolated touch detection process and LCD scan process concurrently executed within spatial domain and time domain, avoiding mutual interference of the two processes.

The execution of the method stated in the invention is completed with LCD touch screen and processor.

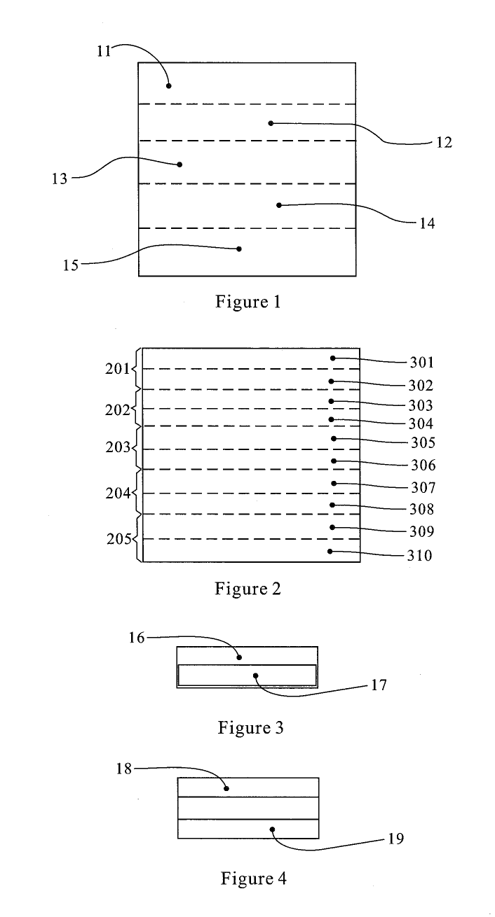

For the first embodiment of the invention as is shown in FIG. 1, LCD touch screen is divided into five regions from Region 11 to Region 15 as per the method of the above Step A, considering from the perspective of simplifying control, the five regions are separated seamlessly, namely, there is no clearance and dead zone for the five regions. In the first embodiment, the said Step B specifically includes the following substeps:

B11. Set sequence of regions executing LCD scan process in the course of completing a frame of LCD scanning data, set sequence of regions executing touch detection process in the course of completing a frame of touch detection data, and ensure that regions executing LCD scan process do not coincidence with regions executing touch detection process within the same time period; the said coincidence includes overlap and intersection.

More specifically, for instance, set the sequence of regions executing LCD scan process during the completion of a frame of LCD scanning data to be Region 11 to Region 15 in execution sequence, obtaining a frame of LCD scan data; set the sequence of regions executing touch detection process during the completion of a frame of touch detection data to be Region 13 to Region 15 in execution sequence, then, from Region 11 to Region 12 in sequence, thus, when touch detection process is executing at Region 13, LCD scan process is executing in Region 11; when touch detection process is executing at Region 14, LCD scan process is executing at Region 12; when touch detection process is executing at Region 15, LCD scan process is executing at Region 13; when touch detection process is executing at Region 11, LCD scan process is executing at Region 14; when touch detection process is executing at Region 12, LCD scan process is executing at Region 15. Thus, the method of executing only one process within one region and the same time frame is realized.

Coincident positional relation of the said regions includes the regional coincident positional relation of an integral region 17 located in the other Region 16. as is shown in FIG. 3, it also comprises the regional intersection positional relation of part of a Region 18 located in the other Region 19 as is shown in FIG. 4.

To adapt to the circumstance that touch detection process and LCD scan process execute at different frequency, the second embodiment of the invention achieves the technological purpose of the invention by means of setting process execution regions for the twp processes respectively, the said Step A comprises the following substeps:

A21. Separate the entire LCD touch screen into at least two touch detection regions seamlessly; as is shown in FIG. 2, in the second embodiment, the LCD touch screen is divided into touch detection region 201 to touch detection region 205;

A22. Then, separate each touch detection region into at least two LCD scan regions without overlapping each other seamlessly; as is shown in FIG. 2, in the second embodiment, touch detection region 2012 is divided into LCD scan region 301 and 302 seamlessly, then, touch detection region 202 is divided into LCD scan region 303 and 304 seamlessly, and the like, thus, LCD touch screen is separated into LCD scan region 301 to LCD scan region 310 seamlessly.

Then, Step B comprises the following sub-steps:

B21. Set the sequence of LCD scan regions executing LCD scan process in the course of completing a frame of LCD scanning data;

B22. Set the sequence of touch detection regions executing touch detection process in the course of completing a frame of touch detection data;

B23. Facilitate the sequences stated in sub-step B21 and B22, ensure that LCD scan regions executing LCD scan process do not coincide with touch detection regions executing touch detection process within the same time period; the said coincidence includes overlap and intersection.

The second embodiment is taken as an example to explain the above Substep B21 to Substep B23 more specifically. For instance, set the sequence of LCD scan regions executing LCD scan process during the completion of a frame of LCD scanning data to be LCD scan region 301 to LCD scan region 310 in execution sequence; set the sequence of touch detection regions executing touch detection process during the completion of a frame of touch detection data to be touch detection region 203 to touch detection region 205 in execution sequence, then, from touch detection region 201 to touch detection region 202 in execution sequence. Thus, when touch detection process is executing at touch detection region 203, LCD scan process is executing at LCD scan region 301; when touch detection process is executing at touch detection region 204, LCD scan process is executing at LCD scan region 302; when touch detection process is executing at touch detection region 205, LCD scan process is executing at LCD scan region 303; when touch detection process is executing at touch detection region 201, LCD scan process is executing at LCD scan region 304; when touch detection process is executing at touch detection region 202, LCD scan process is executing at LCD scan region 305. And so on, when touch detection process has completed two cycles, two frames of touch detection data are obtained, LCD scan process executes from LCD scan region 301 to LCD scan region 310, one cycle of LCD scan process is completed and a frame of LCD scan data are obtained. As stated in Substep B23, facilitating sequences stated in Substep B21 and Substep B22 means verifying the sequence of respective execution regions for the two processes and ensuring nonoccurrence of the coincidence of touch detection region with LCD region.

To further ensure that sequence of regions executing the two processes do not conflict, and update sequence of regions executing the processes, the said Step B23 further comprises the following substeps:

B24. Return to execute Substep B21 after the completion of each one cycle of touch detection process, namely after obtaining a frame of touch detection data;

B25. Return to execute Substep B22 after the completion of each one cycle of LCD scan process, namely obtaining a frame of LCD scanning data.

Still, the specific proposal stated in the above second embodiment is taken as an example, when the touch detection process has completed one cycle, namely, the LCD scan process has completed half a cycle, return to Substep B21, rearrange the sequence of regions executing touch detection process, for example, update the original sequence of touch detection region 203 to 205 in execution sequence, then from touch detection region 201 to 202 in execution sequence to the sequence of touch detection region 204 to 205 in execution sequence, then from touch detection region 201 to 203 in execution sequence.

Similarly, LCD scan process can return to Substep 22 upon completion of one cycle, so as to update the sequence of the process execution regions. For relatively complicated region setting condition, the above Substep B24 and Substep B25 can timely update sequence of the process execution regions, ensuring the nonoccurrence of region coincidence.

The proposal of the above Substep A21 to Substep B25 is based on the condition that touch detection process frequency is higher than the LCD scan process frequency; on the contrary, when touch detection process frequency is lower than the LCD scan process frequency, the following Substeo A51 to Substep B25 can be adopted. The said Step A comprises the following sub-steps:

A51. Separate the entire LCD touch screen into at least two LCD scan regions seamlessly without overlapping each other;

A52. Then, separate each LCD scan region into at least two touch detection regions seamlessly without overlapping each other;

Then, Step B comprises the following sub-steps:

B51. Set the sequence of LCD scan regions executing LCD scan process in the course of completing a frame of LCD scanning data;

B52. Set the sequence of touch detection regions executing touch detection process in the course of completing a frame of touch detection data;

B53. Facilitate the sequences stated in Substep B51 and B22, ensure that LCD scan regions executing LCD scan process do not coincide with touch detection regions executing touch detection process within the same time period; the said coincidence includes overlap and intersection.

Similarly, to timely update the sequence of regions executing the processes, the said Step 53 further comprises the following substeps:

B54. Return to execute Substep B51 after the completion of each one cycle of LCD scan process, namely obtaining a frame of LCD scanning data;

B55. Return to execute Substep B52 after the completion of each one cycle of touch detection process, namely after obtaining a frame of touch detection data.

The above proposal is executed after the controller or processor has preset sequence, namely the timing sequence is relatively definite. In addition, the invention has also put forward the completion of two processes within the same region with noninterference to each other by means of time-sharing control of the two processes, so as to respond to the possible regional coincidence. Under the circumstance that both of the said touch detection process and LCD scan process are divided based on identical regions, the said Step B also comprises the following substeps:

B31. Assign a touch detection sub-cycle for each region, thus, when touch detection process in all regions are completed, a complete touch detection cycle is completed, and a frame of touch detection data are obtained;

B32: Assign an LCD sub-cycle for each region, thus when LCD scan process in all regions are completed, a complete LCD scan cycle is completed, and a frame of LCD scanning data are obtained;

B33. Set either of the said LCD scan process or touch detection process to be master process, while the other process to be slave process; then, the cycle corresponding to the master process shall be major cycle, the sub-cycle corresponding to the said master process shall be sub-cycle of the master process; the cycle corresponding to the said slave process is slave cycle, the sub-cycle corresponding to the said slave process is the sub-cycle of the slave process; execute the following Substep B34-B37 during each major cycle:

B34. Judge whether the execution region of the master process corresponding to the sub-cycle of the master process to be executed coincides with the execution region of the slave process corresponding to the sub-cycle of the slave process to be executed or being executed, if so, execute Substep B35-B36, namely, control the execution of the two processes by time sharing; if not, execute Substep B37, namely controlling the execution of the two processes still according to region division; the said coincidence includes overlap and intersection;

Obviously, frequency of the master process is not always consistent with that of the slave process, therefore, the circumstance that when master process of certain time point has completed one maser process sub-cycle, slave process has not completed one slave process sub-cycle will occur, namely Substep B35:

B35. If sub-cycle of the slave process is being executed, discontinue the execution of the master process, after the sub-cycle of the slave process is completed, discontinue the slave process, start the master process and complete the said sub-cycle of the master process to be executed, discontinue the master process after the completion of the sub-cycle of the master process; return to Substep B34;

When the circumstance that master process and slave process of certain time point respectively completes one master process sub-cycle and one slave process sub-cycle occurs, it is Substep B36.

B36. If sub-cycle of the slave process is to be executed, discontinue the execution of the slave process, start the master process and complete the said sub-cycle of the master process to be executed, after the completion of the said sub-cycle of the master process, discontinue the master process, start the slave process; return to Substep B34;

B37. Execute the master process and the slave process simultaneously, after the master process has completed the said sub-cycle of the master process to be executed, return to Substep B34.

To the proposal that process execution regions are respectively set for touch detection process and LCD scan process, and the circumstance that frequency of touch detection process is higher than that of the LCD scan process, based on the above proposal, the said Step A comprises the following substeps:

A41. Separate the entire LCD touch screen into at least two touch detection regions seamlessly without overlapping each other;

A42. Then, separate each touch detection region into at least two LCD scan regions seamlessly without overlapping each other;

Then, Step B comprises the following sub-steps:

B41. Assign a touch detection sub-cycle to each touch detection region, thus, when touch detection process in all touch detection regions are completed, an entire touch detection cycle is completed, and a frame of touch detection data are obtained;

B42. Assign an LCD sub-cycle to each LCD scan region, thus, when LCD scan process in all LCD scan regions are completed, an entire LCD scan cycle is completed, and a frame of LCD scanning data are obtained;

B43. Set either of the said LCD scan process or touch detection process to be master process, while the other process to be slave process; then, the cycle corresponding to the master process shall be major cycle, the sub-cycle corresponding to the said master process shall be sub-cycle of the master process; the cycle corresponding to the said slave process is slave cycle, the sub-cycle corresponding to the said slave process is the sub-cycle of the slave process; execute the following Substep B44-B47 during the completion of one master cycle;

B44. Judge whether the execution region of the master process corresponding to the sub-cycle of the master process to be executed coincides with the execution region of the slave process corresponding to the sub-cycle of the slave process to be executed or being executed, if so, execute Substep B45-B46, if not, execute Substep B47; the said coincidence includes overlap and intersection;

B45. If sub-cycle of the slave process is being executed, discontinue the execution of the master process, after the sub-cycle of the slave process is completed, discontinue the slave process, start the master process and complete the said sub-cycle of the master process to be executed, discontinue the master process after the completion of the sub-cycle of the master process; return to Substep B44;

B46. If sub-cycle of the slave process is to be executed, discontinue the execution of the slave process, start the master process and complete the said sub-cycle of the master process to be executed, after the completion of the said sub-cycle of the master process, discontinue the master process, start the slave process; return to Substep B44;

B47. Execute the master process and the slave process simultaneously, after the master process has completed the said sub-cycle of the master process to be executed, return to Substep B44.

Similarly, to the proposal that process execution regions are respectively set for touch detection process and LCD scan process, and the circumstance that frequency of touch detection process is lower than that of the LCD scan process, based on the proposal of the above Substep B31 to Substep B37, the said Step A comprises the following substeps:

A61. Separate the entire LCD touch screen into at least two LCD scan regions seamlessly without overlapping each other;

A62. Then, separate each LCD scan region into at least two touch detection regions seamlessly without overlapping each other;

Then, Step B comprises the following sub-steps:

B61. Assign a touch detection sub-cycle to each touch detection region, thus, when touch detection process in all touch detection regions are completed, an entire touch detection cycle is completed, and a frame of touch detection data are obtained;

B62. Assign an LCD sub-cycle to each LCD scan region, thus, when LCD scan process in all LCD scan regions are completed, an entire LCD scan cycle is completed, and a frame of LCD scanning data are obtained;

B63. Set either of the said LCD scan process or touch detection process to be master process, while the other process to be slave process; then, the cycle corresponding to the master process shall be major cycle, the sub-cycle corresponding to the said master process shall be sub-cycle of the master process; the cycle corresponding to the said slave process is slave cycle, the sub-cycle corresponding to the said slave process is the sub-cycle of the slave process; execute the following Substep B64-B67 during the completion of one master cycle;

B64. Judge whether the execution region of the master process corresponding to the sub-cycle of the master process to be executed coincides with the execution region of the slave process corresponding to the sub-cycle of the slave process to be executed or being executed, if so, execute Substep B65-B66, if not, execute Substep B67; the said coincidence includes overlap and intersection;

B65. If sub-cycle of the slave process is being executed, discontinue the execution of the master process, after the sub-cycle of the slave process is completed, discontinue the slave process, start the master process and complete the said sub-cycle of the master process to be executed, discontinue the master process after the completion of the sub-cycle of the master process; return to Substep B64;

B66. If sub-cycle of the slave process is to be executed, discontinue the execution of the slave process, start the master process and complete the said sub-cycle of the master process to be executed, after the completion of the said sub-cycle of the master process, discontinue the master process, start the slave process; return to Substep B64;

B67. Execute the master process and the slave process simultaneously, after the master process has completed the said sub-cycle of the master process to be executed, return to substep B64.

What is claimed is:

1. A method of avoiding mutual interference of touch detection with LCD scan, based on LCD touch screen set with capacitive touch sensor; the said LCD touch screen comprises LCD components and capacitive touch sensor components; the said capacitive touch sensor components and the LCD components are mutually independent and laminated, set to be LCD touch screen, or the said capacitive touch sensor components are inserted between each layer in the LCD components by layers to form LCD touch screen, featuring that the said method comprises the following steps:
A. divide the whole LCD touch screen into at least two regions;
B. set touch detection timing sequence and LCD scan sequence of the LCD touch screen, enable the touch detection process and LCD scan process to meet a process of merely conducting touch detection process and LCD scan process within the same time interval and same region, thus, enabling touch detection process and LCD scan process to keep mutually independent running state either within time domain or spatial domain

2. The method of avoiding mutual interference of touch detection with LCD scan according to claim 1 is characterized in that:
the said Step B comprises the following sub-steps,
B11. set sequence of regions executing LCD scan process in the course of completing a frame of LCD scanning data, set sequence of regions executing touch detection process in the course of completing a frame of touch detection data, and ensure that regions executing LCD scan process do not coincidence with regions executing touch detection process within the same time period; the said coincidence includes overlap and intersection.

3. The method of avoiding mutual interference of touch detection with LCD scan according to claim 1 is characterized in that:
the said Step A comprises the following sub-steps:
A21. separate the entire LCD touch screen into at least two touch detection regions seamlessly without overlapping each other;
A22. then, separate each touch detection region into at least two LCD scan regions seamlessly without overlapping each other;
then, Step B comprises the following sub-steps:
B21. set the sequence of LCD scan regions executing LCD scan process in the course of completing a frame of LCD scanning data;
B22. set the sequence of touch detection regions executing touch detection process in the course of completing a frame of touch detection data;
B23. facilitate the sequences stated in sub-step B21 and B22, ensure that LCD scan regions executing LCD scan process do not coincide with touch detection regions executing touch detection process within the same time period; the said coincidence includes overlap and intersection.

4. The method of avoiding mutual interference of touch detection with LCD scan according to claim 3 is characterized in that:
the said Step B23 further comprises the following substeps,
B24. return to execute Substep B21 after the completion of each one cycle of touch detection process, namely after obtaining a frame of touch detection data;
B25. return to execute Substep B22 after the completion of each one cycle of LCD scan process, namely obtaining a frame of LCD scanning data.

5. The method of avoiding mutual interference of touch detection with LCD scan according to claim 1 is characterized in that:
the said Step B also comprises the following sub-steps,
B31. assign a touch detection sub-cycle for each region, thus, when touch detection process in all regions are completed, a complete touch detection cycle is completed, and a frame of touch detection data are obtained;
B32. assign an LCD sub-cycle for each region, thus when LCD scan process in all regions are completed, a complete LCD scan cycle is completed, and a frame of LCD scanning data are obtained;
B33. set either of the said LCD scan process or touch detection process to be master process, while the other process to be slave process; then, the cycle corresponding to the master process shall be major cycle, the sub-cycle corresponding to the said master process shall be sub-cycle of the master process; the cycle corresponding to the said slave process is slave cycle, the sub-cycle corresponding to the said slave process is the sub-cycle of the slave process; execute the following Substep B34-B37 during each major cycle;
B34. judge whether the execution region of the master process corresponding to the sub-cycle of the master process to be executed coincides with the execution region of the slave process corresponding to the sub-cycle of the slave process to be executed or being executed, if so, execute Substep B35-B36, if not, execute Substep B37; the said coincidence includes overlap and intersection;
B35. if sub-cycle of the slave process is being executed, discontinue the execution of the master process, after the sub-cycle of the slave process is completed, discontinue the slave process, start master process and complete the said sub-cycle of the master process to be executed, discontinue the master process after the completion of the sub-cycle of the master process; return to Substep B34;
B36. if sub-cycle of the slave process is to be executed, discontinue the execution of the slave process, start the master process and complete the said sub-cycle of the master process to be executed, after the completion of the said sub-cycle of the master process, discontinue the master process, start the slave process; return to Substep B34;
B37. execute the master process and the slave process simultaneously, after the master process has completed the said sub-cycle of the master process to be executed, return to Substep B34.

6. The method of avoiding mutual interference of touch detection with LCD scan according to claim 1 is characterized in that:
the said Step A comprises the following sub-steps,
A41. separate the entire LCD touch screen into at least two touch detection regions seamlessly without overlapping each other;
A42. then, separate each touch detection region into at least two LCD scan regions seamlessly without overlapping each other;
then, Step B comprises the following sub-steps,
B41. assign a touch detection cycle to each touch detection region, thus, when touch detection process in all touch detection regions are completed, an entire touch detection cycle is completed, and a frame of touch detection data are obtained;
B42. assign an LCD sub-cycle to each LCD scan region, thus, when LCD scan process in all LCD scan regions are completed, an entire LCD scan cycle is completed, and a frame of LCD scanning data are obtained;
B43. set either of the said LCD scan process or touch detection process to be master process, while the other process to be slave process; then, the cycle corresponding to the master process shall be major cycle, the sub-cycle corresponding to the said master process shall be sub-cycle of the master process; the cycle corresponding to the said slave process is slave cycle, the sub-cycle corresponding to the said slave process is the sub-cycle of the slave process; execute the following Substep B44-B47 during the completion of one master cycle;
B44. judge whether the execution region of the master process corresponding to the sub-cycle of the master process to be executed coincides with the execution region of the slave process corresponding to the sub-cycle of the slave process to be executed or being executed, if so, execute Substep B45-B46, if not, execute Substep B47; the said coincidence includes overlap and intersection;
B45. if sub-cycle of the slave process is being executed, discontinue the execution of the master process, after the sub-cycle of the slave process is completed, discontinue the slave process, start the master process and complete the said sub-cycle of the master process to be executed, discontinue the master process after the completion of the sub-cycle of the master process; return to Substep B44;
B46. if sub-cycle of the slave process is to be executed, discontinue the execution of the slave process, start the master process and complete the said sub-cycle of the master process to be executed, after the completion of the said sub-cycle of the master process, discontinue the master process, start the slave process; return to Substep B44;
B47. execute the master process and the slave process simultaneously, after the master process has completed the said sub-cycle of the master process to be executed, return to Substep B44.

7. The method of avoiding mutual interference of touch detection with LCD scan according to claim 1 is characterized in that:
the said Step A comprises the following sub-steps,
A51. separate the entire LCD touch screen into at least two LCD scan regions seamlessly without overlapping each other;
A52. then, separate each LCD scan region into at least two touch detection regions seamlessly without overlapping each other;
then, step B comprises the following sub-steps,
B51. set the sequence of LCD scan regions executing LCD scan process in the course of completing a frame of LCD scanning data;
B52. set the sequence of touch detection regions executing touch detection process in the course of completing a frame of touch detection data;
B53. facilitate the sequences stated in sub-step B51 and B22, ensure that LCD scan regions executing LCD scan process do not coincide with touch detection regions executing touch detection process within the same time period; the said coincidence includes overlap and intersection.

8. The method of avoiding mutual interference of touch detection with LCD scan according to claim 7 is characterized in that:
the said Step B53 further comprises the following substeps,
B54. return to execute Substep B51 after the completion of each one cycle of LCD scan process, namely obtaining a frame of LCD scanning data.
B55. return to execute Substep B52 after the completion of each one cycle of touch detection process, namely after obtaining a frame of touch detection data.

9. The method of avoiding mutual interference of touch detection with LCD scan according to claim 1 is characterized in that:
the said Step A comprises the following sub-steps,
A61. separate the entire LCD touch screen into at least two LCD scan regions seamlessly without overlapping each other;
A62. then, separate each LCD scan region into at least two touch detection regions seamlessly without overlapping each other;
then, Step B comprises the following sub-steps,
B61. assign a touch detection sub-cycle to each touch detection region, thus, when touch detection process in all touch detection regions are completed, an entire touch detection cycle is completed, and a frame of touch detection data are obtained;
B62. assign an LCD sub-cycle to each LCD scan region, thus, when LCD scan process in all LCD scan regions are completed, an entire LCD scan cycle is completed, and a frame of LCD scanning data are obtained;
B63. set either of the said LCD scan process or touch detection process to be master process, while the other process to be slave process; then, the cycle corresponding to the master process shall be major cycle, the sub-cycle corresponding to the said master process shall be sub-cycle of the master process; the cycle corresponding to the said slave process is slave cycle, the sub-cycle corresponding to the said slave process is the sub-cycle of the slave process; execute the following Substep B64-B67 during the completion of one master cycle;
B64. judge whether the execution region of the master process corresponding to the sub-cycle of the master process to be executed coincides with the execution region of the slave process corresponding to the sub-cycle of the slave process to be executed or being executed, if so, execute Substep B65-B66, if not, execute Substep B67; the said coincidence includes overlap and intersection;
B65. if sub-cycle of the slave process is being executed, discontinue the execution of the master process, after the sub-cycle of the slave process is completed, discontinue the slave process, start the master process and complete the said sub-cycle of the master process to be executed, discontinue the master process after the completion of the sub-cycle of the master process; return to Substep B64;
B66. if sub-cycle of the slave process is to be executed, discontinue the execution of the slave process, start the master process and complete the said sub-cycle of the master process to be executed, after the completion of the said sub-cycle of the master process, discontinue the master process, start the slave process; return to Substep B64;
B67. execute the master process and the slave process simultaneously, after the master process has completed the said sub-cycle of the master process to be executed, return to Substep B64.
